(19) United States
(12) Patent Application Publication
(10) Pub. No.: US 2009/0244745 A1
(43) Pub. Date: Oct. 1, 2009

(54) OPTICAL FILTER AND METHOD FOR MANUFACTURING OPTICAL FILTER

(75) Inventor: Yo KOMURO, Chiba (JP)

Correspondence Address: HOWARD & HOWARD ATTORNEYS PLLC, 450 West Fourth Street, Royal Oak, MI, 48067, US

(73) Assignee: SEIKO PRECISION INC., Chiba (JP)

(21) Appl. No.: 12/057,550

(22) Filed: Mar. 28, 2008

(51) Int. Cl. G02B 5/28

(52) U.S. Cl. 359/885; 264/1.7

(57) ABSTRACT

An optical filter 10 that attenuates visible light has a flat plate 11 that is flat, wing-shaped, and of a predetermined hardness, and a light attenuating region 10a provided at part of the flat plate 11. Carbon nanotubes and nickel particles, at least some of which are supporting ends of the carbon nanotubes, are dispersed in the flat plate 11. In the present invention, the optical filter 10 is then formed by using nickel particles as catalytic particles during synthesis of the carbon nanotubes and then dispersing the nickel particles and the carbon nanotubes in a resin.

### BACKGROUND OF THE INVENTION

1. Field of the Invention

The present invention relates to an optical filter utilizing carbon nanotubes and a method for manufacturing the optical filter.

2. Description of the Related Art

Conventionally, optical filters (ND filters; Natural Density Filters) that reduce intensity of light incident to an imaging device such as for a camera or a video camera by a specific proportion are employed when photographing locations where light is intense using an imaging device or when the texture of photographs and images changes. Filters where an absorption agent that absorbs light of a specific wavelength is dispersed in resin material, or filters with an inorganic film deposited on the surface exist as this kind of optical filter. Further, filters where ink dispersed with carbon nanotubes is applied to a transparent substrate are disclosed in Unexamined Japanese Patent KOKAI Publication No. 2004-145054.

The filter disclosed in Unexamined Japanese Patent KOKAI Publication No. 2004-145054 is formed by applying ink dispersed with carbon nanotubes (Carbon Nanotubes; hereinafter referred to as CNTs) to the surface of a substrate such as transparent glass or plastic. The CNTs are electrically conductive. It is also possible to suppress the occurrence of electrostatic electricity in optical filters with a sliding operation if the filter disclosed in Unexamined Japanese Patent KOKAI Publication No. 2004-145054 is applied.

On the other hand, light transmittance increases as the wavelength of light lengthens with CNTs. The use of CNTs in ND filters that are to obtain a substantially uniform transmission characteristic regardless of wavelength of the light is therefore difficult.

Further, for example, vapor phase epitaxial method is used when synthesizing large amounts of CNTs. In this case, CNTs are grown using nickel particles as catalytic particles. The CNTs are formed with ends supported at the nickel particles. The nickel particles then however constitute impurities with respect to CNTs when growth is complete. This is because of the possibility of the nickel particles adversely affecting the CNTs at the time of use. For example, the CNTs are electrically conducting but the electrical conductivity may become unstable as a result of the influence of the nickel particles. In order to put an end to this kind of inconvenience, it is preferable to remove the nickel particles supporting the CNTs after completion of CNT growth. However, it is necessary to provide a purification process that is separated from the process for producing the CNTs in order to remove the nickel particles. A process for producing CNTs with the nickel particles removed however becomes quite complex. As a result, the cost of making CNTs increases and in turn causes the price of any optical filters made using the CNTs to rise.

Moreover, selective removal of nickel particles from the CNTs is extremely difficult and an effective way of selectively eliminating nickel particles from the CNTs has not as yet been established.

It is therefore desirable to achieve a way of manufacturing optical filters that have a substantially uniform transmission characteristic with respect to wavelength and have superior optical characteristics in a more straightforward and cheaper way.

### SUMMARY OF THE INVENTION

The present invention solves the problems described above. It is an object of the present invention to provide an optical filter that is both cheap and has superior optical characteristics and a method for manufacturing the optical filter.

In order to achieve the above object, an optical filter of a first aspect of the present invention is formed from resin that carbon nanotubes and metallic particles are mixed into. At least some of the metallic particles support ends of the carbon nanotubes.

The metallic particles are preferably nickel.

The external diameter of the carbon nanotubes is preferably 300 nm or less.

The carbon nanotubes are preferably mixed at a proportion of 0.01 to 20% by weight.

The particle diameter of the metallic particles is preferably 300 nm or less.

The metallic particles are preferably mixed at a proportion of 0.01 to 20% by weight.

In order to achieve the above object, a method for manufacturing an optical filter of a second aspect of the present invention comprises a carbon nanotube forming step of forming carbon nanotubes taking metallic particles as catalytic particles, a filter material forming step of forming filter material by dispersing said carbon nanotubes and metallic particles used as catalytic particles in a resin that is molten and transparent, a filling step of injecting the filter material into a die having cavities corresponding to the shape of the optical filter so as to fill the cavities with the filter material, a step of hardening the filter material the cavities are filled with, and an extracting step of extracting the optical filter from the die.

Metallic particles can be dispersed in the filter material forming step in addition to the metallic particles used as catalytic particles.

### BRIEF DESCRIPTION OF THE DRAWINGS

These objects and other objects and advantages of the present invention will become more apparent upon reading of the following detailed description and the accompanying drawings in which:

FIG. 1A is a view showing an example configuration for an optical filter of an embodiment of the present invention;

FIG. 1B is a cross-sectional view along I-I shown in FIG. 1A;

FIG. 2 is a view showing an imaging device mounted with an optical filter of the embodiment of the present invention;

FIG. 3 is a graph showing light transmittance of a CNT layer formed on a transparent film;

FIG. 4 is a graph showing light transmittance of a nickel layer formed on a transparent film;

FIG. 5 is a graph showing light transmittance when a CNT layer and a nickel layer are formed on a transparent film;

FIG. 6 is a view schematically showing a situation where ends of carbon nanotubes are supported at the fine metallic particles; and

FIG. 7 is a cross-sectional view of a fixed mold and a movable mold used in the manufacture of optical filters of the preferred embodiment of the present invention.

### DETAILED DESCRIPTION OF THE PREFERRED EMBODIMENT

A description is now given using the drawings of an optical filter and a method for manufacturing the optical filter of an embodiment of the present invention.

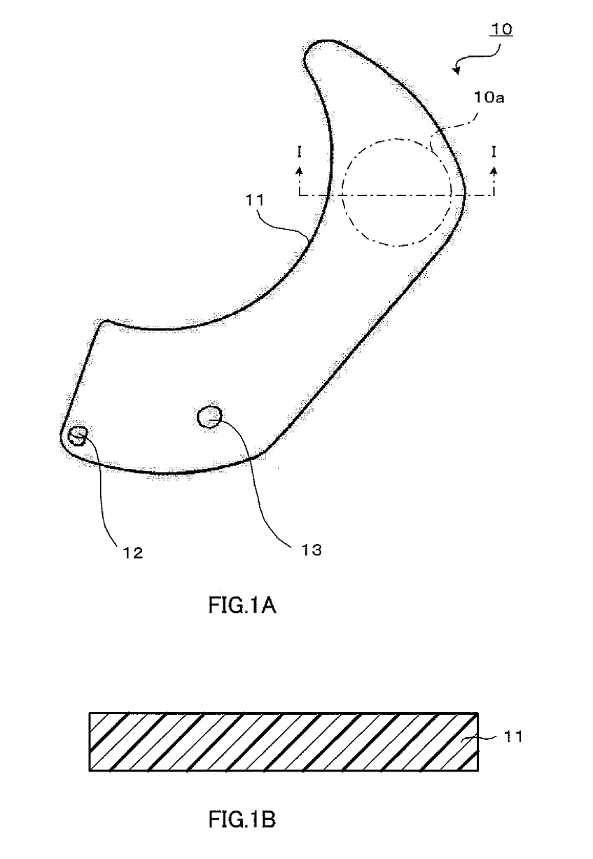

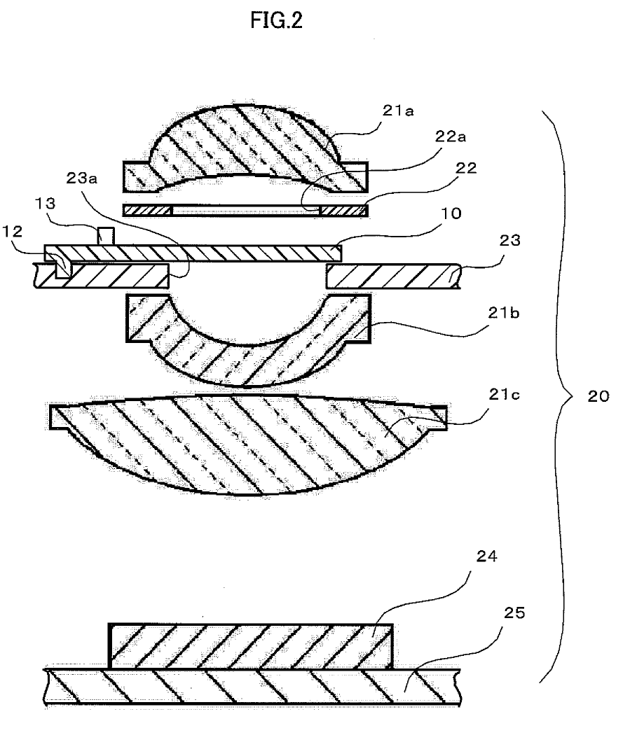

An optical filter 10 of the embodiment of the present invention is shown in FIG. 1A and FIG. 1B. FIG. 1A is a plan view showing an example configuration for the optical filter 10. FIG. 1B is a cross-sectional view along I-I of FIG. 1A. FIG. 2 is a view schematically depicting the imaging device 20 employing the optical filter 10.

As shown in FIG. 1A, the optical filter 10 has a flat plate 11, a rotatable pin 12, and an actuating pin 13. The flat plate 11 is shaped like a flat plate, has blades, and is of a predetermined hardness. The rotatable pin 12 is formed at one end of the flat plate 11. The actuating pin 13 is formed at one end of the flat plate 11 and is formed projecting towards a surface opposite the rotatable pin 12. Incident light then passes through a region (light attenuating region 10a) of part of the flat plate 11 shown by a single dotted and dashed line in FIG. 1A and is attenuated by a predetermined amount.

The optical filter 10 is installed within the imaging device 20, as shown in FIG. 2. The rotatable pin 12 fits into a hole on a filter support substrate 23 and functions as a center of rotation of the optical filter 10. The actuating pin 13 is made to operate by an actuator (not shown). The optical filter 10 rotates centered about the rotatable pin 12. The flat plate 11, the rotatable pin 12 and the actuating pin 13 are integrally molded as described in the following.

When the optical filter 10 is positioned so as to block an opening 23a of the filter support substrate 23 as shown in FIG. 2, the light attenuating region 10a covers the opening 23a and light incident from an opening 22a of an aperture 22 is attenuated by a predetermined amount. The light attenuating region 10a has the same or a larger surface area as the opening 23a of the filter support substrate 23 and the opening 22a of the aperture 22. Light incident to the imaging device 20 only passes through the light attenuating region 10a. This means that the proportion by which light is attenuated at least the light attenuating region 10a is substantially fixed with respect to wavelength. In this embodiment, light is principally attenuated by CNTs and nickel particles dispersed within the flat plate 11. It is therefore appropriate for the CNTs and nickel to have a substantially fixed distribution at least the light attenuating region 10a. Further, the surface of the flat plate 11 is formed in an irregular manner as a result of dispersal of the CNTs within the flat plate 11. This ensures that reflections occurring at the surface of the flat plate 11 are effectively suppressed.

As shown in FIG. 2, the imaging device 20 has lenses 21a to 21c, the aperture 22, the optical filter 10, the filter support substrate 23, an imaging element 24, and a substrate 25. The optical filter 10 is installed on the filter support substrate 23 within the imaging device 20. The rotatable pin 12 fits into a hole provided at the filter support substrate 23. The actuating pin 13 engages with the actuator (not shown). When the actuator drives the actuating pin 13, the optical filter 10 rotates centered about the rotatable pin 12, and the light attenuating region 10a blocks and unblocks the opening 23a of the filter support substrate 23. The light attenuating region 10a then attenuates light incident from the lens 21a and the aperture 22. The proportion by which light is attenuated is substantially fixed at the visible light region. The color of light reaching the CCDs (Charge Coupled Devices) installed on the substrate 25, and imaging elements 24 such as CMOSs (Complementary Metal Oxide Semiconductor) therefore is of little consequence.

The flat plate 11 is formed by mixing CNTs and nickel powder in transparent resin. The flat plate 11 is made to be lightweight to an extent where a rotating operation is still possible and is therefore, for example, 30 μm to 200 μm thick.

It is sufficient for the transparent resin constituting the flat plate 11 to be optically transparent. For example, PC (Polycarbonate), PMMA (Polymethylmethacrylate), PS (Polystyrene), PET (Poly Ethylene Terephthalate), PES (Poly Ether Sulfone), alicyclic olefin resin, aicyclic acrylic resin, norbornene heat-resistant transparent resin, and acrylic olefin copolymer, etc. can be used as the transparent resin.

The CNTs dispersed in the flat plate 11 are made from carbon and are in the shape of hollow cylinders. When the diameters of the CNTs are too thick, visible light is dispersed and cloudiness occurs. For example, an external diameter of 10 to 300 nm and a length of 0.1 to 30 μm is desirable for the CNTs. Further, it is necessary for the proportion of visible light attenuated by the optical filter 10 to be fixed. The proportion of light attenuated by the optical filter 10 becomes higher for large amounts of added CNTs and becomes lower for small amounts of added CNTs. The rate of adding CNT is then adjusted according to the proportion of attenuation required for the optical filter 10. When the rate of adding CNT to the resin is increased, the viscosity of the filter material increases. There is then the possibility that this may hinder printing for the filter material and forming of CNT layers, etc. It is therefore necessary to decide the amount of CNT added in view of the required rate of attenuation of light, printing, and ability to mold, etc. In this embodiment, CNTs are added to the extent of 0.01 to 20% by weight.

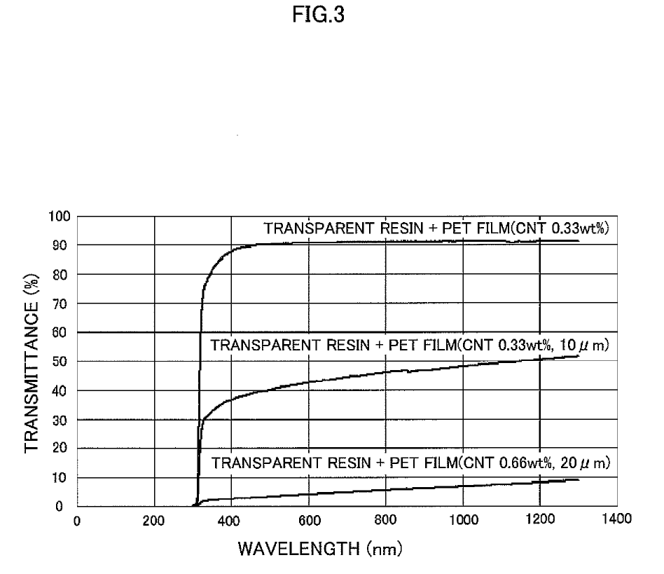

Further, CNTs dispersed within the flat plate 11 have the optical characteristics shown in FIG. 3. FIG. 3 shows transmittance to light of a transparent film (PET film) formed on the surface of a CNT layer mixed with transparent resin. A transparent resin 10 μm thick with 0% by weight of CNTs added, a transparent resin 10 μm thick with 0.33% by weight of CNTs added, and a transparent resin 20 μm thick with 0.66% by weight of CNTs added are each formed on a transparent film (75 μm thick) and irradiated with light of a continuously changing wavelength. Transmittance is then measured. As is clear from FIG. 3, a transparent film formed only from transparent resin that has not had any CNTs added exhibits a substantially fixed transmittance with respect to wavelength. On the other hand, when CNTs are added 0.33% by weight, and when CNTs are added 0.66% by weight, in either case transmittance increases as wavelength lengthens. It can therefore be said that changes in transmittance according to wavelength are derived from CNTs.

It is preferable for the nickel particles dispersed in the flat plate 11 to have a particle diameter in the order of one tenth or less of the wavelength of the visible light region in order to prevent scattering. Specifically, the particle diameter of the nickel particles is preferably 300 nm or less. Further, when the number of dispersed nickel particles is small, attenuation of light is insufficient and uniform dispersion is difficult. On the other hand, when the number of dispersed nickel particles is too large, the viscosity of the resin the nickel particles are dispersed in increases and printing etc. becomes difficult. It is therefore preferable for nickel particles to be mixed in to the order of 0.01 to 20 % by weight with respect to the transparent resin.

In this embodiment, nickel particles are dispersed in the flat plate 11 and are used as catalytic particles during synthesis of CNT. As described in the following, the CNTs are grown from nickel particles, with ends of the tube-shaped CNTs being supported at (fixed to) the nickel particles. At least some of the nickel particles are therefore dispersed in a state of attachment to ends of the CNTs.

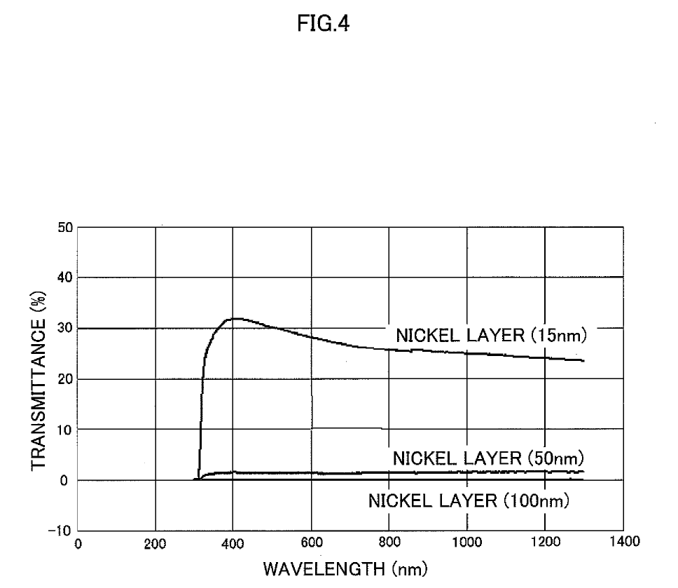

Further, nickel particles dispersed within the flat plate 11 have the optical characteristics shown in FIG. 4. FIG. 4 shows transmittance obtained by forming nickel layers to thicknesses of 15 nm, 50 nm, and 100 nm onto a transparent film (PET film) using sputtering and then irradiating with light while continuously varying wavelength. The thickness of the transparent film is 100 μm. In this embodiment, a configuration is adopted where nickel particles are dispersed in resin but substantially the same characteristics can be obtained for experimental results where a nickel layer is formed using sputtering because the particle diameter is small. As is clear from FIG. 4, when a nickel layer 100 nm thick is provided, light of almost any wavelength does not pass. Even for a thickness of 50 nm, just around 2% of light passes and transmittance does not change substantially with respect to wavelength. On the other hand, when a nickel layer is formed to a thickness of 15 nm, 20 to 30% of light passes, with transmittance markedly falling as the wavelength becomes long. When a nickel layer equipped with a transmittance of greater than 2% is formed, the nickel layer exhibits a characteristic where transmittance falls as wavelength becomes longer.

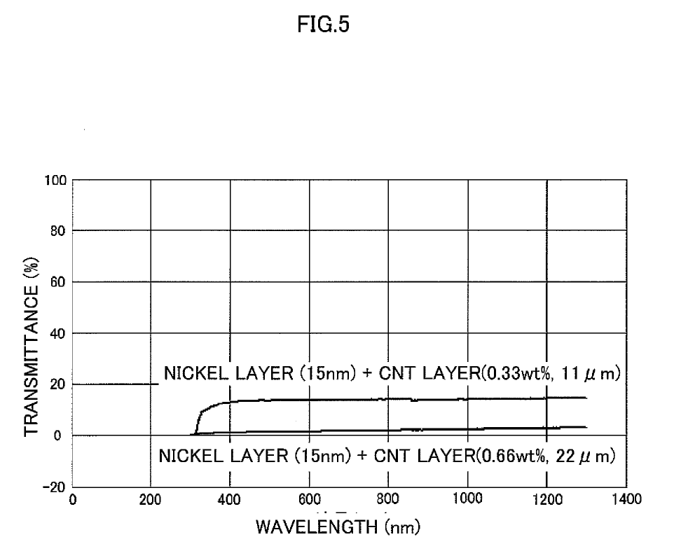

A transparent film where a nickel layer and CNT layer are formed on a transparent film also has the transmittance characteristics shown in FIG. 5. With this transparent film, a nickel layer 15 nm thick is formed by vapor deposition of nickel onto a transparent film (PET film) 100 μm thick. Transparent resin with CNTs added is then printed onto the nickel layer and a transparent resin layer is formed. The transmittance characteristics shown in FIG. 5 are transmittance characteristics for a transparent film where thickness of a transparent resin layer CNT is added to and the amount of CNTs added to the transparent resin are changed. Specifically, the transmittance of a transparent film having an 11 μm CNT layer with CNT added at a rate of 0.33% by weight and a transparent film having a 22 μm CNT layer with CNT added at a rate of 0.66% by weight is measured. As becomes clear from comparing FIGS. 3, 4, and 5, it can be understood that, as a result of forming an overlaid nickel layer and CNT layer, the transmittance characteristics of gradients for the respective wavelengths are substantially uniform with respect to the wavelength of the light.

As a result of being configured from the flat plate 11 formed of transparent resin dispersed with CNTs and nickel, the optical filter 10 of this embodiment is furnished with a substantially uniform transmittance characteristic with respect to wavelength by having the transmittance characteristic for the CNTs and the transmittance characteristic for the nickel particles alternately complement each other.

Further, the CNTs are dispersed at the upper surface of the optical filter 10 of this embodiment. The surface of the optical filter 10 is therefore irregular. It is therefore possible to suppress the reflection of light generated at the surface of the optical filter 10. The CNTs are electrically conductive. This means that even if the optical filter 10 within the imaging device 20 shown in FIG. 2 is rotated, the optical filter 10 suppresses occurrence of electrostatic electricity in an effective manner.

In this embodiment, the optical filter 10 is formed by injection molding. The rotatable pin 12 and the actuating pin 13 are formed integrally with the flat plate 11. Strength of a composition plane for the rotatable pin 12, the actuating pin 13 and the flat plate 11 is therefore increased. Superior strength is therefore provided with respect to the rotating operation of the rotatable pin 12, the actuating pin 13 and the optical filter 10.

Next, a description is given using the drawings of a method of manufacturing the optical filter 10 of the preferred embodiment of the present invention.

First, the CNTs are synthesized. The CNTs are synthesized using typically employed vapor phase epitaxial method. For example, first, fine metallic particles such as nickel as catalytic particles on the substrate are supported, and the substrate is installed within a chamber. Next, the chamber is supplied with gas containing carbon. A high temperature chemical reaction is then caused to take place, and CNT is grown on the fine metallic particles on the substrate. The CNTs can also be formed using vapor flow techniques.

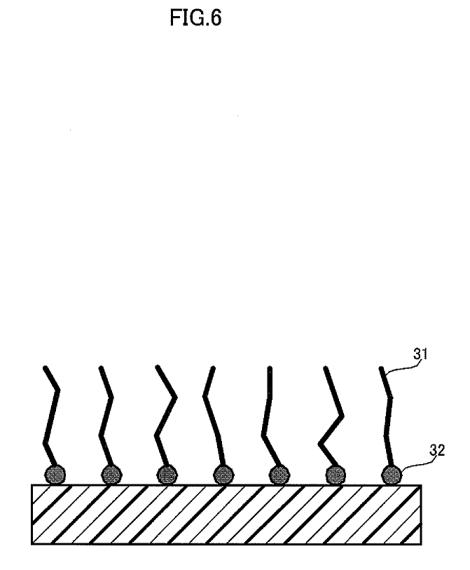

The CNTs formed as a result are rooted as pluralities or single CNTs using the forming conditions on fine metallic particles and are grown on the fine metallic particles. Ends of the synthesized CNTs 31 are then supported at the fine metallic particles 32, as shown in FIG. 6.

Next, the CNTs with the catalytic particles attached are mixed with a binder resin and agitated. The binder resin is then mixed in with the resin so that the CNTs are dispersed in a substantially uniform manner so as to form the filter material. The amount of CNT generated through synthesis and the amount of nickel particles used as catalytic particles can be regulated in advance in order to attain the portions required by the optical filter being made. It is not essential for all of the nickel particles to be used as the catalytic particles required by the optical filter. It is also possible to use some of the nickel particles as catalytic particles and add the remaining nickel particles during the forming of the filter material.

The filter material can be constituted by, for example, PC (Polycarbonate), PMMA (Polymethylmethancrylate), PS (Polystyrene), PET (Poly Ethylene Terephthalate), PES (Poly Ether Sulfone), alicyclic olefin resin, aicyclic acrylic resin, norbornene heat-resistant transparent resin, and acrylic olefin copolymer, etc. The filter material is preferably formed by adding 0.01 to 20% by weight of CNTs to molten resin and then mixing in 0.01 to 20% by weight of nickel particles.

When the diameters of the CNTs are too thick, the filter causes cloudiness as a result of scattering of visible light. For example, it is preferable to use CNTs of diameters of 300 nm or less and lengths of, for example, 0.1 to 30 μm. When not enough CNTs are added to the resin, it becomes difficult for the optical filter to obtain sufficient light attenuation properties and uniform dispersion of the CNTs also becomes troublesome. On the other hand, when too many CNTs are added to the resin, the viscosity of the resin containing the CNTs increases and printing and molding etc. of the resin become difficult. It is therefore preferable to mix in 0.01 to 20% by weight of CNT into the binder.

The nickel particles also prevent scattering of wavelengths in the visible light region. It is therefore preferable for the particle diameters of the nickel particles to be in the order of one tenth or less of the wavelength of the visible light region. Specifically, the particle diameter of the nickel particles is preferably 300 nm or less. Further, when the number of dispersed nickel particles is small, it is difficult for the optical filter to obtain sufficient light attenuation and it is also difficult to disperse the nickel particles in a uniform manner. On the other hand, when there are too many nickel particles for the resin, the viscosity of the resin containing the nickel particles increases. This makes printing and molding etc. for the resin difficult. It is therefore preferable for the nickel particles to be mixed in to the order of 0.01 to 0.20% by weight with respect to the binder resin.

This filter material is then introduced into a cavity 93 at a predetermined temperature and pressure using an injection cylinder (not shown) via a sprue, runner 95, and gate 94. The filter material is injected via the gate 94 running along a surface direction of the cavity 93. The CNTs in the filter material therefore have a tendency to become aligned with a surface direction of the optical filter 10. Similarly, the CNTs within the cavities 93a, 93b have a tendency to become aligned vertically with respect to the surface direction of the optical filter 10. The CNTs within the filter material can therefore be easily aligned in specific directions and the strength of the rotatable pin 12 and actuating pin 13 is therefore increased.

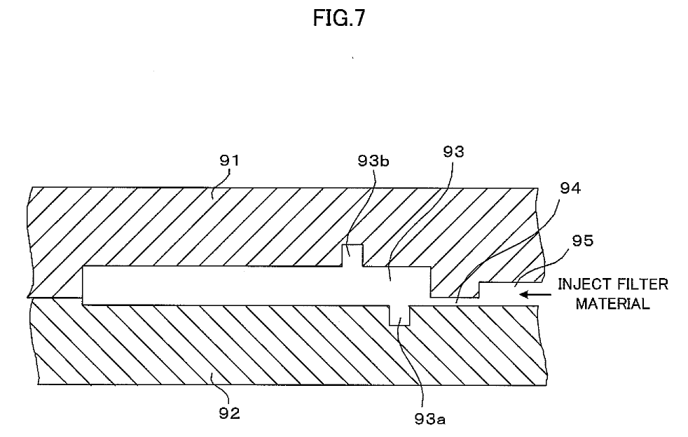

In this embodiment, the optical filter 10 is formed by injection molding. A cross-section of a mold used in this injection molding is shown schematically in FIG. 7. As shown in FIG. 7, a fixed mold 91 and a movable mold 92 are provided with the cavity 93 corresponding to the optical filter 10, the cavity 93a corresponding to the rotatable pin 12, a cavity 93b corresponding to the actuating pin 13, the gate 94, and the runner 95. The cavity 93b is formed at the fixed mold 91 and the cavity 93a is formed at the movable mold 92. The cavity 93 is formed taking into consideration contraction during hardening of the filter material where CNTs and nickel particles are dispersed on the solder beforehand. It is also possible to form a number of cavities at the fixed mold 91 and the movable mold 92 so that a number of optical filters 10 can be formed at the same time.

The filter material is hardened after the cavities 93, 93a, and 93b are filled up with the filter material.

After the filter material hardens, the movable mold 92 is moved and the optical filter 10 is extracted using projecting pins (not shown). The optical filter 10 is then complete.

In the manufacturing method of this embodiment, by dispersing CNTs and nickel particles in a binder resin and forming a light attenuating layer, it is possible to manufacture the optical filter 10 having a substantially uniform transmittance characteristic with respect to wavelength by utilizing the characteristic of the nickel layer where transmittance falls as wavelength lengthens and the characteristic of the CNT layer where transmittance increases as wavelength lengthens.

In this embodiment, the nickel particles used as catalytic particles during synthesis of the CNTs are mixed in resin in a state fixed to the CNTs. However, in the manufacturing method of this embodiment, a process of refining the CNT to eliminate nickel particles is by no means essential. Namely, according to the present invention, it is possible to make the optical filter using unrefined CNTs. It is, however, possible to make optical filters cheaply using CNTs.

Further, in this embodiment, the nickel particles are dispersed within the resin in a state with ends of the CNTs supported by the nickel particles. It is therefore possible to disperse the CNT and the nickel particles in the resin in a substantially uniform manner.

Further, in this embodiment, nickel particles are used as catalytic particles. As a result, the present invention differs from the related art in that the process for making the nickel layer is straightforward, whereas in the related art a metal oxide film and a nickel film etc. were formed on the film using vacuum deposition etc. Moreover, in the method of the related art, there were also limitations in that the filter had to be of a predetermined thickness in the case of using vacuum deposition etc. However, in this embodiment, the optical filter is formed using injection molding. The degree of freedom with respect to shape, size and thickness of the optical filter therefore increases and control of the thickness of the filter is also straightforward. It is therefore possible to omit processes such as removal steps etc. by molding the optical filter 10 to the required size and the amount of waste created can also be reduced. It is also possible to form the rotatable pin 12 and the actuating pin 13 at the same time. It is further possible to omit a process for forming the rotatable pin 12 etc. at the filter.

The CNTs are also dispersed at the surface of the optical filter 10 and the surface of the optical filter 10 is formed in an irregular manner. Steps such as fine processing of surfaces that were required in the related art in order to prevent reflection at the surface of the filter can therefore be omitted.

As described above, the method for manufacturing an optical filter of this embodiment is capable of eliminating a number of processes that were required in the related art. It is therefore possible to reduce manufacturing costs.

The present invention is by no means limited to the embodiment described above and various modifications and applications are possible. For example, in the above embodiment, an example is given of a configuration where nickel particles are used as metallic particles. However, it is also possible to use material other than nickel particles as the catalyst during synthesis of the CNTs and any material is possible providing that optical properties of the material are such that there is greater absorption for short wavelength regions than for long wavelength regions.

Further, a configuration is adopted where the actuating pin 13 is actuated by the actuator as a result of rotating centrally about the rotatable pin 12 so as to rotate the optical filter 10, but this is by no means limiting. For example, it is also possible to just provide the actuating pin and rotate the actuator pin using an actuator etc. Appropriate changes can then be made to the configuration for rotating and driving the optical filter 10. It is also possible to have the rotatable pin 12 and the actuating pin 13 at the same surface. The optical filter 10 can also be provided with a guide.

In the above embodiment, a description is given of a configuration where filter material is injected from a lateral direction of the fixed mold 91 and the movable mold 92 but this configuration is by no means limiting. A configuration can also be adopted where filter material is injected from a vertical direction for locations other than the light attenuating region 10a. Moreover, a description is given of the case where the cavity 93b is formed corresponding to the actuating pin 13 at the fixed mold 91 and the cavity 93a corresponding to the rotatable pin 12 is formed at the movable mold 92 but this is by no means limiting. For example, it is also possible to form a cavity corresponding to the rotatable pin 12 at the fixed mold 91. The fixed mold 91 and the movable mold 92 can also be changed appropriately in line with the shape of the optical filter 10.

The optical filter of the present invention can be used in imaging devices such as cameras and video cameras. Further, the method for manufacturing an optical filter of the present invention is applicable to manufacturing of optical filters used in imaging devices such as cameras and video cameras.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

What is claimed is:

1. An optical filter comprising: a resin of carbon nanotubes and metallic particles mixed together,
wherein at least some of the metallic particles support ends of the carbon nanotubes.

2. The optical filter according to claim 1, wherein the metallic particles comprise nickel.

3. The optical filter according to claim 1, wherein an external diameter of the carbon nanotubes is 300 nm or less.

4. The optical filter according to claim 1, wherein the carbon nanotubes are mixed at a proportion of 0.01 to 20% by weight.

5. The optical filter according to claim 1, wherein a particle diameter of the metallic particles is 300 nm or less.

6. The optical filter according to claim 1, wherein the metallic particles are mixed at a proportion of 0.01 to 20% by weight.

7. A method for manufacturing an optical filter, comprising:
a carbon nanotube forming step of forming carbon nanotubes taking metallic particles as catalytic particles;
a filter material forming step of forming filter material by dispersing said carbon nanotubes and metallic particles used as catalytic particles in a resin that is molten and transparent;
a filling step of injecting the filter material into a die having cavities corresponding to the shape of the optical filter so as to fill the cavities with the filter material;
a step of hardening the filter material the cavities are filled with; and
an extracting step of extracting the optical filter from the die.

8. The method for manufacturing an optical filter according to claim 7, wherein the metallic particles comprise nickel.

9. The method for manufacturing an optical filter according to claim 7, wherein metallic particles are dispersed in the filter material forming step in addition to the metallic particles used as catalytic particles.

10. The method for manufacturing an optical filter according to claim 7, wherein an external diameter of the carbon nanotubes is 300 nm or less.

11. The method for manufacturing an optical filter according to claim 7, wherein the carbon nanotubes are mixed at a proportion of 0.01 to 20% by weight.

12. The method for manufacturing an optical filter according to claim 7, wherein a particle diameter of the metallic particles is 300 nm or less.

13. The method for manufacturing an optical filter according to claim 7, wherein the metallic particles are mixed at a proportion of 0.01 to 20% by weight.
